(19) United States
(12) Patent Application Publication
(10) Pub. No.: US 2024/0102879 A1
(43) Pub. Date: Mar. 28, 2024

(54) LIQUID LEAKAGE DETECTION SYSTEM AND LIQUID LEAKAGE SENSOR

(71) Applicant: ROHM CO., LTD., Kyoto (JP)

(72) Inventors: Shunsuke AKASAKA, Kyoto (JP); Takashi NAIKI, Kyoto (JP)

(21) Appl. No.: 18/449,758

(22) Filed: Aug. 15, 2023

(30) Foreign Application Priority Data
Sep. 28, 2022 (JP) 2022-154371

(51) Int. Cl. G01M 3/16

(52) U.S. Cl. CPC G01M 3/16

(57) ABSTRACT

A liquid leakage detection system that detects a liquid includes: a liquid leakage sensor including a first detector that detects adhesion of the liquid based on a change in impedance between a first electrode and a second electrode; and a control device that acquires information including the impedance between the first electrode and the second electrode, wherein the liquid leakage sensor includes a heater that heats the first electrode and the second electrode, and wherein the control device determines whether or not liquid leakage or dew condensation has occurred based on the impedance between the first electrode and the second electrode that are in a state of being heated by the heater, and notifies the determination result.

### CROSS-REFERENCE TO RELATED APPLICATION

This application is based upon and claims the benefit of priority from Japanese Patent Application No. 2022-154371, filed on Sep. 28, 2022, the entire contents of which are incorporated herein by reference.

### TECHNICAL FIELD

The present disclosure relates to a liquid leakage detection system and a liquid leakage sensor.

### BACKGROUND

A liquid leakage sensor having comb-like electrodes is known. The liquid leakage sensor may make an erroneous detection due to occurrence of dew condensation in a high-humidity environment. The liquid leakage sensor has a humidity detector in addition to a liquid leakage detector. A determinator determines whether liquid leakage has occurred based on detection results of both the liquid leakage detector and the humidity detector.

More specifically, when the liquid leakage detector detects liquid leakage and a measurement result of the humidity detector is 80% or higher, the determinator waits until a predetermined period of time (for example, twenty-four hours) elapses. A liquid leakage alarm is output when the liquid leakage detector still detects the liquid leakage even after the predetermined period of time has elapsed.

### BRIEF DESCRIPTION OF DRAWINGS

The accompanying drawings, which are incorporated in and constitute a part of the specification, illustrate embodiments of the present disclosure.

FIG. 1 is a block diagram for explaining an overall configuration of a liquid leakage detection system having a liquid leakage sensor according to a first embodiment.

FIG. 2 is an exploded perspective view of the liquid leakage sensor according to the first embodiment.

FIGS. 3A and 3B are a cross-sectional view and a plan view of the liquid leakage sensor according to the first embodiment, respectively.

FIG. 4 is a flowchart for detecting occurrence of liquid leakage or dew condensation according to the first embodiment.

FIG. 5 is a diagram showing a table for determining a surrounding state of the liquid leakage sensor.

FIG. 6 is a block diagram for explaining an overall configuration of a liquid leakage detection system having a liquid leakage sensor according to a second embodiment.

FIG. 7 is a plan view of the liquid leakage sensor according to the second embodiment.

FIG. 8 is a flowchart for detecting occurrence of liquid leakage or dew condensation according to the second embodiment.

FIG. 9 is a block diagram for explaining an overall configuration of a liquid leakage detection system having a liquid leakage sensor according to a third embodiment.

FIGS. 10A and 10B are a cross-sectional view and a plan view of the liquid leakage sensor according to the third embodiment, respectively.

FIG. 11 is a flowchart of an abnormality determination process for a heater according to the third embodiment.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

The details of embodiments of the present disclosure will be described with reference to the drawings. Throughout the drawings, the same or corresponding parts are denoted by the same reference numerals, and duplicate explanation thereof will not be repeated.

### First Embodiment

### <Overall Configuration of Liquid Leakage Detection System According to First Embodiment>

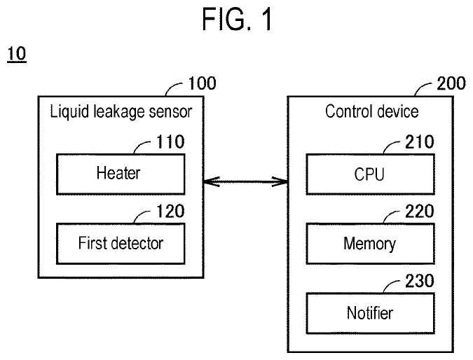

FIG. 1 is a block diagram for explaining an overall configuration of a liquid leakage detection system 10 having a liquid leakage sensor 100 according to a first embodiment. The liquid leakage detection system 10 is a system for detecting liquid leakage used in, for example, factories, homes, and the like. Liquids to be detected include pure substances and mixtures, oils used in industrial equipment in factories, liquids in batteries, etc., and various liquids such as refrigerants used for air conditioners, household wastewater, etc. in homes.

The liquid leakage detection system 10 includes the liquid leakage sensor 100 and a control device 200. The liquid leakage sensor 100 and the control device 200 are electrically connected to each other. A connection method between the liquid leakage sensor 100 and the control device 200 may be wired or wireless.

The liquid leakage sensor 100 includes a heater 110 and a first detector 120. The heater 110 in the first embodiment is a micro-heater in the field of micro electro mechanical systems (MEMS). In addition, the heater 110 is not limited to the micro-heater and may be a sheathed heater or the like. The first detector 120 detects adhesion of liquid based on a change in impedance between electrodes which will be described later. The heater 110 heats the electrodes included in the first detector 120.

The control device 200 includes a CPU 210, a memory 220, and a notifier 230. The CPU 210 executes programs temporarily stored in the memory 220. Processing in the control device 200 is implemented by cooperation of respective hardware and software executed by the CPU 210. The notifier 230 notifies information such as occurrence of liquid leakage to the outside according to a command from the CPU 210. The notifier 230 may include, for example, a lamp, a display, and a speaker.

<Configuration of Liquid Leakage Sensor according to First Embodiment>

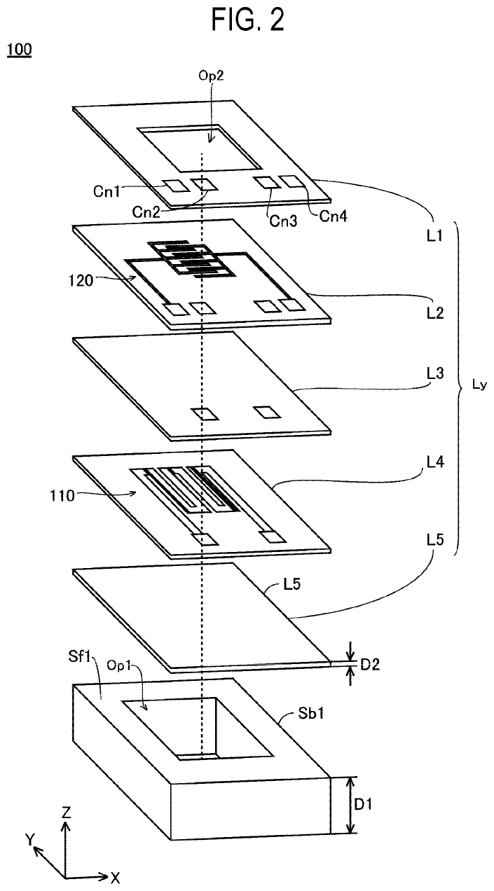

FIG. 2 is an exploded perspective view of the liquid leakage sensor 100 according to the first embodiment. The liquid leakage sensor 100 is configured by arranging an insulator Ly on a main surface Sf1 of a substrate Sb1. As shown in FIG. 2, the insulator Ly has a structure in which a plurality of insulating layers L1 to L5 is stacked. Hereinafter, a stacking direction of the plurality of insulating layers L1 to L5 is referred to as a “Z-axis direction.” A direction perpendicular to the Z-axis direction and along one side of the substrate Sb1 in a plan view of the main surface Sf1 is referred to as an “X-axis direction.” A direction perpendicular to both the X-axis direction and the Z-axis direction is referred to as a “Y-axis direction.” In each drawing, a positive direction of the Z-axis may be referred to as an upper side, and a negative direction thereof may be referred to as a lower side.

As shown in FIG. 2, the substrate Sb1 having the main surface Sf1 is arranged on a negative direction side of the Z-axis of the liquid leakage sensor 100. A length D1 of the substrate Sb1 in the Z-axis direction is, for example, several hundred micro-meters. An opening Op1 penetrating in the Z-axis direction is formed in the substrate Sb1. In other words, the opening Op1 penetrates the substrate Sb1 along a thickness direction of the substrate Sb1. That is, the substrate Sb1 of the first embodiment has a frame shape when viewed from a positive direction side of the Z-axis. In a certain aspect, the opening Op1 may be closed on the negative direction side of the Z-axis without penetrating the substrate Sb1. The opening Op1 is a region for forming a space for bringing air into contact with a surface of the insulating layer L5 on the negative direction side of the Z-axis. The substrate Sb1 is made of, for example, single crystalline silicon.

The substrate Sb1 supports the plurality of insulating layers L1 to L5 arranged on the main surface Sf1. The insulating layers L1 to L5 are stacked on the main surface Sf1 in the order of the insulating layers L5, L4, L3, L2, and L1 from the negative direction side of the Z-axis. The insulating layers L1 to L5 are made of, for example, silicon nitride or silicon oxide. A length D2 of the insulating layer L5 in the Z-axis direction is 11 μm to 10 μm. Lengths of the insulating layers L1 to L4 in the Z-axis direction are also 11 μm to 10 μm, like the insulating layer L5.

The heater 110 is arranged in the insulating layer L4. Vias for connecting the heater 110 and connectors Cn2 and Cn3 are arranged in the insulating layer L3. In addition to vias for connecting the heater 110 and the connectors Cn2 and Cn3, the first detector 120 is arranged in the insulating layer L2. Connectors Cn1 to Cn4 are arranged in the insulating layer L1. The insulating layer L1 may correspond to a “first insulating layer” in the present disclosure. The insulating layer L2 may correspond to a “second insulating layer” in the present disclosure. The insulating layer L4 may correspond to a “third insulating layer” in the present disclosure.

An opening Op2 penetrating in the Z-axis direction is formed in the insulating layer L1, similarly to the substrate Sb1. In other words, the opening Op2 penetrates the insulating layer L1 along a thickness direction of the insulating layer L1. That is, the insulating layer L1 has a frame shape when viewed from the positive direction side of the Z-axis.

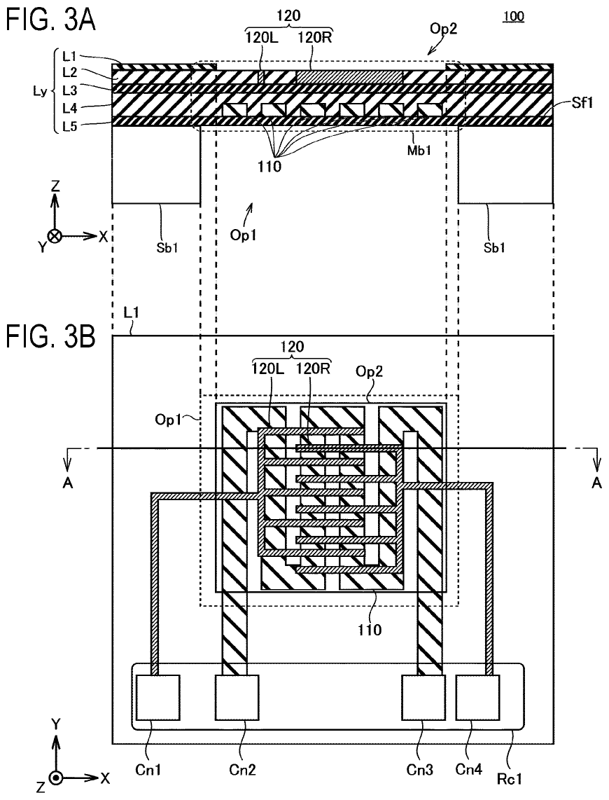

In the liquid leakage detection system 10 according to the first embodiment, an impedance between the electrodes included in the first detector 120 under an unheated state and an impedance between the electrodes included in the first detector 120 under a heated state are used to detect liquid leakage. When a space in which the liquid leakage sensor 100 is installed is cooled, for example, by an air conditioner, dew condensation may occur on a surface of the liquid leakage sensor 100. In this case, an electrical resistance value between the electrodes included in the first detector 120 may decrease even when no liquid leakage occurs, which may cause erroneous detection. Therefore, in the liquid leakage detection system 10, it is possible to distinguish, by using the heater 110, whether the decrease in impedance between the electrodes included in the first detector 120 is caused by adhesion of liquid due to liquid leakage or caused by occurrence of dew condensation due to a high-humidity environment. A detection method by the liquid leakage sensor 100 according to the first embodiment will be described below with reference to FIGS. 3A to 5.

FIGS. 3A and 3B are a cross-sectional view and a plan view of the liquid leakage sensor 100 according to the first embodiment, respectively. FIG. 3A is a cross-sectional view of the liquid leakage sensor 100 when viewed from the negative direction side of the Y-axis. FIG. 3B is a transparent plan view of the liquid leakage sensor 100 when viewed from the positive direction side of the Z-axis.

The cross section shown as FIG. 3A is a cross section of the liquid leakage sensor 100 taken along line A-A in FIG. 3B. FIG. 3B shows the opening Op2 and the connectors Cn1 to Cn4 in the insulating layer L1, the first detector 120 in the insulating layer L2, the heater 110 in the insulating layer L4, and the opening Op1 in the substrate Sb1 in order from the positive direction side of the Z-axis.

The first detector 120 includes a first electrode 120L arranged on the negative direction side of the X-axis and a second electrode 120R arranged on the positive direction side of the X-axis. The first electrode 120L is connected with the connector Cn1. The second electrode 120R is connected with the connector Cn4. The connectors Cn1 and Cn4 are connectors for connecting the first detector 120 and an external device. The first detector 120 is configured to be capable of detecting a change in impedance between the first electrode 120L and the second electrode 120R by measuring a voltage or the like between the connectors Cn1 and Cn4. The connectors Cn1 and Cn4 are an example of a “second connector” in the present disclosure.

As shown in FIG. 3B, the first electrode 120L and the second electrode 120R have a combteeth-like shape. The first electrode 120L and the second electrode 120R are conductors containing, for example, aluminum, copper, or platinum. In other words, a base material of the first detector 120 contains aluminum, copper, or platinum.

As shown in FIG. 3A, the opening Op2 formed in the insulating layer L1 exposes at least a portion of the first detector 120 included in the insulating layer L2. In other words, the first electrode 120L and the second electrode 120R are exposed in a region overlapping with the opening Op2 when the main surface Sf1 is viewed from the positive direction side of the Z-axis. The region overlapping with the opening Op2 is a region occupied by a space surrounded by the frame-shaped insulating layer L1 when the insulating layer L1 is viewed from the positive direction side of the Z-axis. As a result, liquid adheres to a surface between the first electrode 120L and the second electrode 120R exposed from the opening Op2, thereby changing the impedance between the connector Cn1 and the connector Cn4.

An example of a change in impedance is, for example, a decrease in electrical resistance value between the connectors Cn1 and Cn4 due to adhesion of conductive liquid between the connectors Cn1 and Cn4. In addition, the change in impedance may include a change in electrostatic capacitance due to a change in dielectric constant between the connectors Cn1 and Cn4 due to adhesion of non-conductive liquid between the connectors Cn1 and Cn4. Hereinafter, a surface on the positive direction side of the Z-axis, including the first electrode 120L and the second electrode 120R that are exposed from the opening Op2, and the insulating layer L1, is collectively referred to as an exposed surface.

At least a portion of the heater 110 is arranged at a position overlapping with the first electrode 120L and the second electrode 120R when the main surface Sf1 is viewed from the positive direction side of the Z-axis. The heater 110 is composed of a strip electrode arranged in a meandering shape. A base material of the electrode forming the heater 110 is, for example, Ti, Cr, Ta, and nitrides thereof, Al, Pt, Au, and alloys thereof, and the like. One end of the electrode forming the heater 110 is connected to the connector Cn2 through a via, and the other end thereof is connected to the connector Cn3 through a via. The connectors Cn2 and Cn3 are connectors for connecting the heater 110 and an external device. The heater 110 generates resistance heat by being energized via the connectors Cn2 and Cn3. The connectors Cn2 and Cn3 are an example of a “first connector” in the present disclosure.

The first electrode 120L and the second electrode 120R are heated by the resistance heat generated by the heater 110. Thus, when water droplets adhere to the exposed surface, the water droplets evaporate. That is, the liquid leakage sensor 100 of the first embodiment can evaporate the water droplets generated by dew condensation in a high-humidity environment, thereby causing the exposed surface to transition to a state similar to a state in which no dew condensation occurs.

As shown in FIG. 3B, the heater 110 is arranged at a position overlapping with the opening Op1 of the main surface Sf1 when viewed from the positive direction side of the Z-axis. A thermal resistance of air is greater than a thermal resistance of a base material forming the substrate Sb1. Therefore, by forming the opening Op1 in the substrate Sb1, the heat generated by the heater 110 is efficiently transferred to the first detector 120 as compared with a case where the opening Op1 is not formed. That is, in the liquid leakage sensor 100 according to the first embodiment, since the substrate Sb1 is not arranged on the negative direction side of the Z-axis of the heater 110 due to the formation of the opening Op1, unnecessary heat transfer to the substrate Sb1 is suppressed. In the following description, a film-shaped region in which the insulating layers L1 to L5 or the insulating layers L2 to L5 only overlap with one another when viewed from the positive direction side of the Z-axis shown in FIG. 3A is referred to as a membrane Mb1.

As shown in FIG. 3B, a waterproof resin Rc1 is arranged on the positive direction side of the Z-axis of the connectors Cn1 to Cn4. In other words, the connectors Cn1 to Cn4 are covered with the waterproof resin Rc1. As a result, in the liquid leakage sensor 100 according to the first embodiment, it is possible to suppress generation of water droplets due to dew condensation or liquid leakage in a vicinity of the connectors Cn1 to Cn4 and suppress generation of a short circuit between the connectors Cn1 to Cn4.

### <State Determination Process According to First Embodiment>

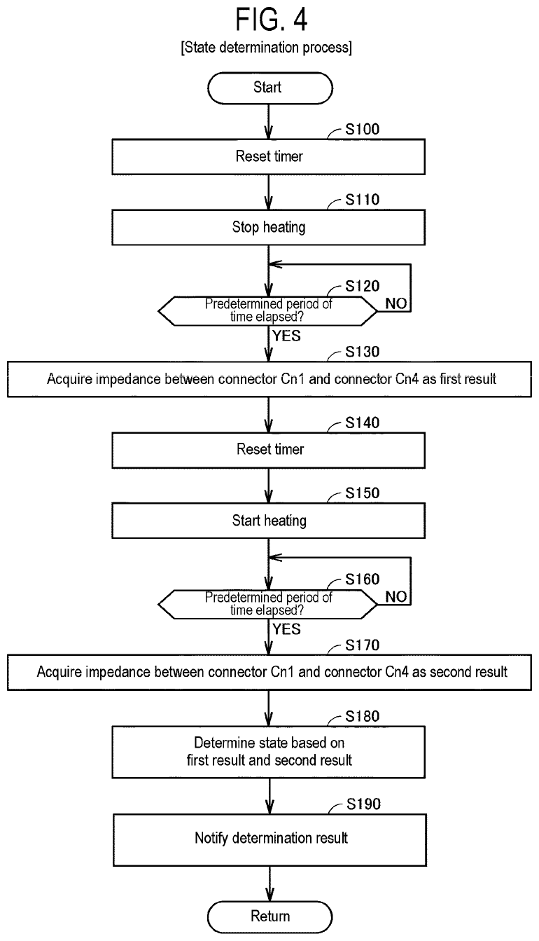

FIG. 4 is a flowchart for detecting occurrence of liquid leakage or dew condensation according to the first embodiment. The flowchart shown in FIG. 4 is implemented by the CPU 210 that reads the programs stored in the memory 220. In the liquid leakage detection system 10 according to the first embodiment, by executing the flowchart shown in FIG. 4, it is possible to distinguish and detect whether dew condensation has occurred due to cooling a space in which the liquid leakage sensor 100 is installed or liquid leakage has occurred.

The CPU 210 resets a timer (step S100). The timer in step S100 is, for example, a general-purpose timer installed in the CPU 210. In the present embodiment, resetting the timer means resetting a timer count to an initial value (zero seconds) and starting counting.

The CPU 210 causes the heater 110 to stop heating (step S110). That is, the CPU 210 sets the heater 110 to be a non-energized state. As described above, when the space in which the liquid leakage sensor 100 is installed is cooled in a high-humidity environment, the dew condensation may occur on the surface of the liquid leakage sensor 100.

The CPU 210 uses the timer reset in step S100 to determine whether or not a predetermined period of time has elapsed (step S120). The predetermined period of time in step S120 is a period sufficient for water droplets to adhere to the exposed surface when dew condensation may occur, such as when the space where the liquid leakage sensor 100 is installed is cooled in a high-humidity environment. The predetermined period of time in step S120 is, for example, ten to fifteen minutes. In addition, the liquid leakage sensor 100 of the first embodiment may be provided with a moisture absorber on the exposed surface in order to shorten the predetermined period of time in step S160.

When the predetermined period of time has not elapsed after step S100 (“NO” in step S120), the CPU 210 repeats the process of step S120. When the predetermined period of time has elapsed after step S100 (“YES” in step S120), the CPU 210 acquires information including the impedance between the connector Cn1 and the connector Cn4 as a first result (step S130).

The impedance between the connector Cn1 and the connector Cn4 includes an impedance between the first electrode 120L and the second electrode 120R. The CPU 210 determines whether or not the liquid adheres between the first electrode 120L and the second electrode 120R, according to whether or not the impedance indicated as the first result is equal to or greater than a predetermined threshold value. That is, the first result is information that indicates whether or not the liquid adheres to the unheated exposed surface. The predetermined threshold value is determined in advance based on shapes and base materials of the first electrode 120L and the second electrode 120R, a base material of the first insulating layer, and the like.

After acquiring the first result, the CPU 210 resets the timer (step S140). Subsequently, the CPU 210 causes the heater 110 to start heating (step S150). That is, the CPU 210 energizes the heater 110. When dew condensation occurs due to a high-humidity environment, water droplets adhering to the exposed surface evaporate due to the resistance heat generated by the heater 110. The CPU 210 supplies electric power so that a temperature of the heater 110 is set to be equal to or higher than an environmental temperature around the liquid leakage sensor 100 and equal to or lower than 200 degrees C. As a result, in liquid leakage sensor 100 according to the first embodiment, since an upper limit of the temperature of the heater 110 is 200 degrees C., occurrence of a failure of the liquid leakage sensor 100 due to excessive temperature rise can be suppressed. The liquid leakage sensor 100 acquires the surrounding environmental temperature by using a temperature sensor (not shown) that detects a temperature around the liquid leakage sensor 100.

The CPU 210 uses the timer reset in step S140 to determine whether or not a predetermined period of time has elapsed (step S160). The predetermined period of time in step S160 is a period sufficient for the heater 110 to evaporate the water droplets adhering to the exposed surface when the water droplets adhere to the exposed surface. The predetermined period of time in step S160 is determined in advance by, for example, a base material of the heater 110 and a magnitude of a current supplied to the heater 110. The predetermined period of time is, for example, one second to ten seconds.

When the predetermined period of time has not elapsed (“NO” in step S160), the CPU 210 repeats the process of step S160. When the predetermined period of time has elapsed (“YES” in step S160), the CPU 210 acquires information including the impedance between the connector Cn1 and the connector Cn4 as a second result (step S170). The second result is information that indicates whether or not the liquid adheres to the exposed surface in a heated state. The CPU 210 determines a surrounding state of the liquid leakage sensor 100 based on the first result and the second result (step S180).

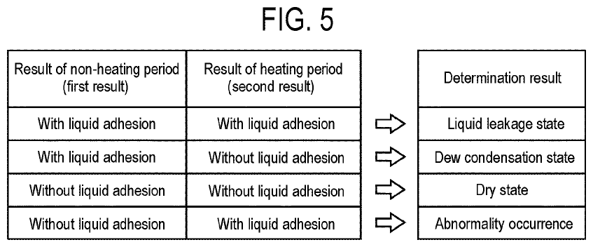

FIG. 5 is a diagram showing a table for determining the surrounding state of the liquid leakage sensor 100. The table shown in FIG. 5 is stored as a program in a storage device such as a ROM (not shown). The CPU 210 reads the program showing the table of FIG. 5 from the storage device. As shown in FIG. 5, the CPU 210 derives the determination result of the surrounding state of the liquid leakage sensor 100 based on the first result and the second result.

The first result and the second result are information indicative of whether or not the liquid adheres to the exposed surface. When both the first result and the second result indicate the adhesion of the liquid, the CPU 210 determines that the exposed surface has an amount of liquid that cannot be evaporated by heating the heater 110 and thus that the liquid leakage has occurred around the liquid leakage sensor 100. That is, when the first result indicates the adhesion of the liquid and the second result also indicates the adhesion of the liquid, the CPU 210 determines that the liquid leakage has occurred.

When the first result indicates the adhesion of the liquid and the second result does not indicate the adhesion of the liquid, the CPU 210 determines that the exposed surface has an amount of liquid that can be evaporated by heating the heater 110 and thus that dew condensation has occurred around the liquid leakage sensor 100. When both the first result and the second result do not indicate the adhesion of the liquid, the CPU 210 determines that the liquid does not exist on the exposed surface and thus that the surroundings of the liquid leakage sensor 100 are in a dry state. When the first result does not indicate the adhesion of the liquid and the second result indicates the adhesion of the liquid, the CPU 210 determines that an abnormality has occurred.

As described above, the CPU 210 determines the surrounding state of the liquid leakage sensor 100 based on the table shown in FIG. 5. Returning to FIG. 4, the CPU 210 causes the notifier 230 to notify the determination result (step S190). When the notifier 230 is a display, the CPU 210 causes the notifier 230 to display characters that correspond to the determination result. When the notifier 230 is a lamp, the CPU 210 lights the lamp in colors that correspond to the determination result. A user can recognize the occurrence of liquid leakage or dew condensation and the presence or absence of an abnormality in the liquid leakage sensor 100 by the notification by the notifier 230.

In the first embodiment, the CPU 210 may repeatedly execute the flowchart shown in FIG. 4 every predetermined period of time. In addition, in a certain aspect, the CPU 210 may not acquire the second result when the first result of step S130 does not indicate the adhesion of the liquid. That is, the CPU 210 may start heating the heater 110 only when the first result indicates the adhesion of the liquid. In the liquid leakage detection system 10 as described above, the temperature of the heater 110 is not increased unless the first result indicates the adhesion of the liquid, so that power consumption can be suppressed.

In the liquid leakage detection system 10 of the first embodiment, even when the dew condensation occurs in the high-humidity environment, by evaporating the water droplets due to the dew condensation by the heater 110, it is possible to distinguish whether a decrease in impedance is caused by the adhesion of the liquid due to the occurrence of the liquid leakage or caused by the occurrence of the dew condensation due to the high-humidity environment. As a result, the liquid leakage detection system 10 of the first embodiment can detect the liquid leakage while preventing erroneous detection even in the high-humidity environment.

### Second Embodiment

Differences in a configuration of a second embodiment from that of the first embodiment will be described. Regarding the liquid leakage sensor 100 of the first embodiment described above, the example has been described in which the liquid leakage is detected while suppressing erroneous detection due to the dew condensation by repeating energization and non-energization of the heater 110. In the second embodiment, a liquid leakage sensor 100A includes a second detector 121 in addition to the first detector 120, so that the liquid leakage and the dew condensation are distinguished without executing a control to repeat energization and non-energization of the heater 110. In the second embodiment, explanation of the configuration overlapping with that of the first embodiment will not be repeated.

### <Overall Configuration of Liquid Leakage Detection System According to Second Embodiment>

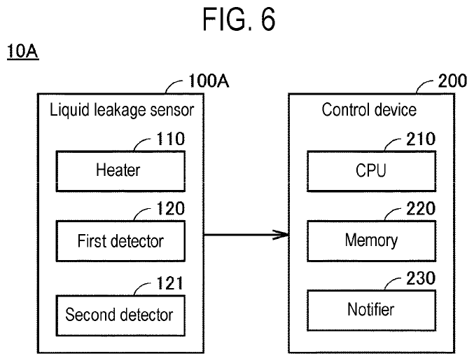

FIG. 6 is a block diagram for explaining an overall configuration of a liquid leakage detection system 10A having the liquid leakage sensor 100A according to the second embodiment.

As shown in FIG. 6, the liquid leakage sensor 100A according to the second embodiment has the second detector 121 in addition to the first detector 120. The second detector 121 detects adhesion of a liquid based on a change in impedance between electrodes, similarly to the first detector 120. In the second embodiment, the heater 110 heats the electrodes included in first detector 120, but does not heat electrodes included in the second detector 121.

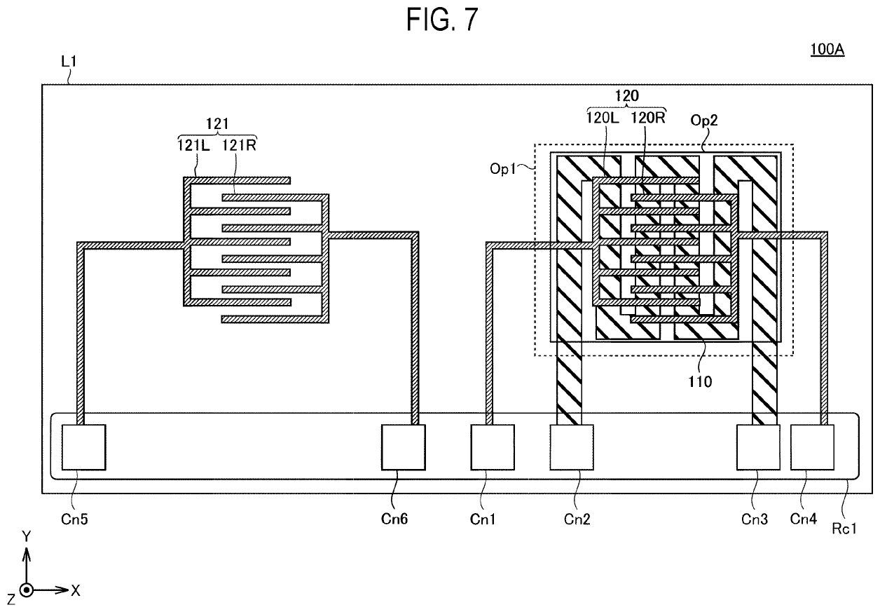

FIG. 7 is a plan view of the liquid leakage sensor 100A according to the second embodiment. As shown in FIG. 7, the second detector 121 is arranged on the negative direction side of the X-axis of the first detector 120. In the second embodiment, the second detector 121 is arranged in the insulating layer L2, like the first detector 120. As a result, since the first detector 120 and the second detector 121 are formed on the same insulating layer L2, a manufacturing process of the liquid leakage sensor 100A is simplified as compared with a case where the first detector 120 and the second detector 121 are formed in different layers.

The second detector 121 includes a third electrode 121L arranged on the negative direction side of the X-axis and a fourth electrode 121R arranged on the positive direction side of the X-axis. The third electrode 121L is connected with a connector Cn5. The fourth electrode 121R is connected with a connector Cn6. The connectors Cn5 and Cn6 are connectors for connecting the second detector 121 and an external device. The second detector 121 is configured to be capable of detecting a change in impedance between the third electrode 121L and the fourth electrode 121R by measuring a voltage or the like between the connectors Cn5 and Cn6. In the second embodiment, the waterproof resin Rc1 covers the connectors Cn5 and Cn6 in addition to the connectors Cn1 to Cn4.

As shown in FIG. 7, the third electrode 121L and the fourth electrode 121R have a combteeth-like shape. The third electrode 121L and the fourth electrode 121R are conductors containing, for example, aluminum, copper, or platinum. In other words, a base material of the second detector 121 contains aluminum, copper, or platinum. As described above, the second detector 121 has the same shape as the first detector 120.

In the second embodiment, the heater 110 is not arranged at a position overlapping with the second detector 121 when viewed from the positive direction side of the Z-axis. Accordingly, the second detector 121 is not heated by the heater 110. That is, in the second embodiment, the water droplets adhering to the second detector 121 are not evaporated in a state where dew condensation occurs. Thus, in the second embodiment, the second detector 121 is used to acquire the first result, and the first detector 120 is used to acquire the second result.

Since it is not necessary to provide a micro-heater for the second detector 121, in a certain aspect, the second detector 121 may be formed in the insulating layer L1. That is, it is not necessary to perform a process of forming, in the insulating layer L1 on the positive direction side of the Z-axis of the second detector 121, an opening for exposing the second detector 121, which reduces a burden in the manufacturing process.

### <State Determination Process According to Second Embodiment>

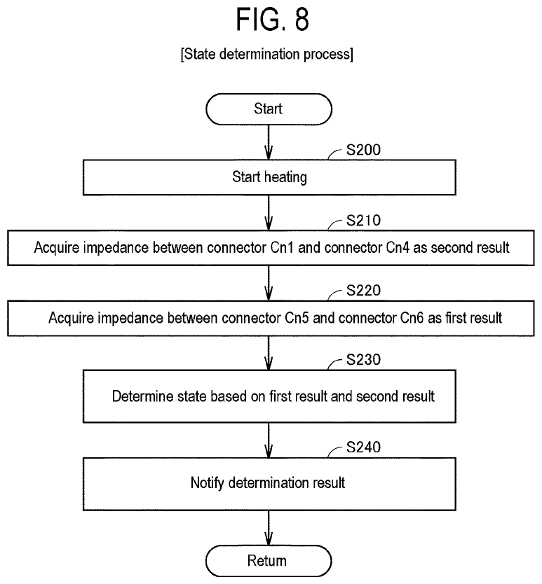

FIG. 8 is a flowchart for detecting occurrence of liquid leakage or dew condensation according to the second embodiment. In the second embodiment, the CPU 210 causes the heater 110 to start heating (step S200). Accordingly, when water droplets adhere to the exposed surface of the first detector 120 due to dew condensation, the water droplets evaporate. The CPU 210 acquires information including the impedance between the connector Cn1 and the connector Cn4 as a second result (step S210).

The second result in the second embodiment is information that indicates whether or not liquid adheres to the exposed surface of the first detector 120 in a heated state. After acquiring the second result, the CPU 210 acquires information including the impedance between the connector Cn5 and the connector Cn6 as a first result (step S220). The first result in the second embodiment is information that indicates whether or not liquid adheres to an exposed surface of the second detector 121 in an unheated state. The CPU 210 determines a surrounding state of the liquid leakage sensor 100A based on the first result and the second result (step S230).

Also in the second embodiment, the surrounding state of the liquid leakage sensor 100A is determined in step S230 by using the table shown in FIG. 5. Subsequently, the CPU 210 causes the notifier 230 to notify the determination result (step S240).

As described above, in the liquid leakage detection system 10A of the second embodiment, without repeating the energization of the heater 110 using a timer, it is possible to determine the surrounding state of the liquid leakage sensor 100A while maintaining the state of the energization of the heater 110. That is, in the second embodiment, it is possible to distinguish the occurrence of liquid leakage from the occurrence of dew condensation in real time and determine the surrounding state of the liquid leakage sensor 100A. In addition, in the second embodiment, since a control using a timer is not performed, it is possible to determine the surrounding state of the liquid leakage sensor 100A with a simple processing procedure.

### Third Embodiment

Differences in a configuration of a third embodiment from that of the first embodiment will be described. A liquid leakage sensor 100B of the third embodiment has a configuration in which a temperature sensor 130 is added to the configuration of the first embodiment. In the third embodiment, the explanation of the configuration overlapping with that of the first embodiment will not be repeated. In addition, the second detector 121 of the second embodiment may be combined with the third embodiment.

### <Overall Configuration of Liquid Leakage Detection System According to Third Embodiment>

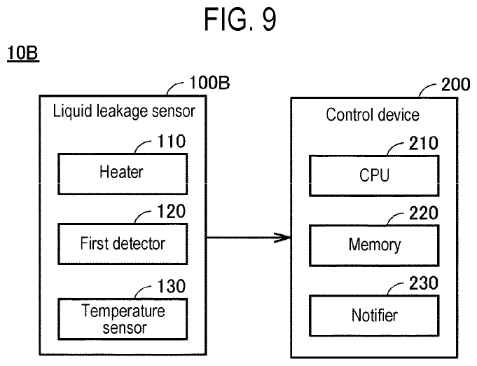

FIG. 9 is a block diagram for explaining an overall configuration of a liquid leakage detection system 10B having the liquid leakage sensor 100B according to the third embodiment.

As shown in FIG. 9, the liquid leakage sensor 100B according to the third embodiment has the temperature sensor 130 in addition to the heater 110 and the first detector 120. The temperature sensor 130 detects the temperature of the heater 110.

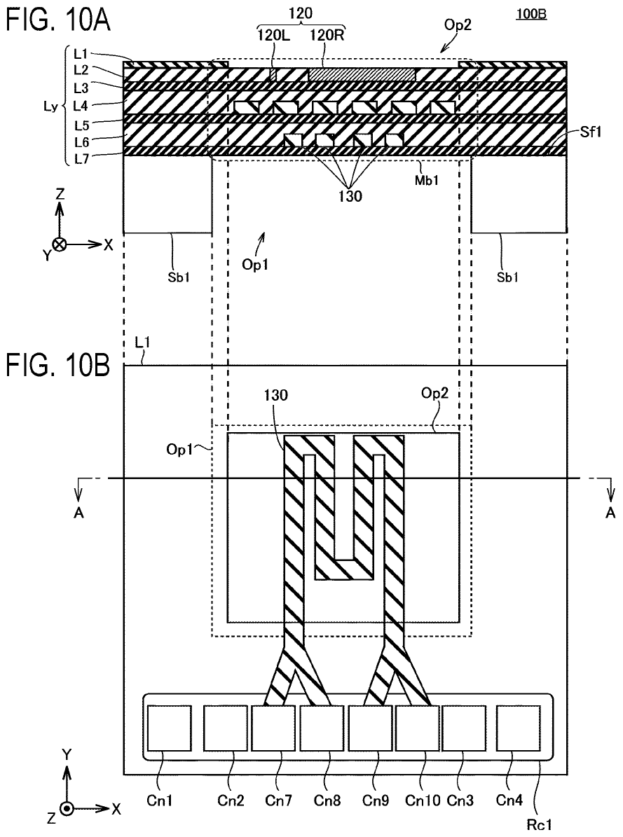

FIGS. 10A and 10B are a cross-sectional view and a plan view of the liquid leakage sensor 100B according to the third embodiment, respectively. FIG. 10A is a cross-sectional view of the liquid leakage sensor 100B when viewed from the negative direction side of the Y-axis. FIG. 10B is a transparent plan view of the liquid leakage sensor 100B when viewed from the positive direction side of the Z-axis. In FIG. 10B, an illustration of the first detector 120 and the heater 110 is omitted to simplify the explanation.

As shown in FIG. 10A, the insulator Ly in the third embodiment has insulating layers L6 and L7 in addition to the insulating layers L1 to L5. The insulating layers L6 and L7 are arranged between the insulating layer L5 and the substrate Sb1. A base material of the insulating layers L6 and L7 is the same as the base material of the insulating layers L1 to L5.

As shown in FIG. 10A, the insulating layer L6 includes the temperature sensor 130. The temperature sensor 130 is arranged inside the membrane Mbl. As shown in FIG. 10B, the temperature sensor 130 has a meandering shape in a plan view from the positive direction side of the Z-axis. The temperature sensor 130 overlaps with the heater 110 in a plan view. The temperature sensor 130 functions as a resistance thermometer. That is, a temperature in a vicinity of the temperature sensor 130 is measured by measuring a change in impedance of a wiring forming the temperature sensor 130. A base material of the temperature sensor 130 is, for example, platinum.

As shown in FIG. 10A, the temperature sensor 130 is connected to connectors Cn7 to Cn10. The connectors Cn7 to Cn10 are connectors for connecting an external device and the temperature sensor 130. In order to suppress detection of an unnecessary resistance value in the wiring, the temperature sensor 130 is configured as a four-wiring connection type resistance thermometer in which two wirings are connected to each end of a resistive element. The temperature sensor 130 may be a two-wiring or three-wiring connection type resistance thermometer. In the third embodiment, the control device 200 uses a detected value of the temperature sensor 130 to determine whether or not an abnormality has occurred in the heater 110.

### <Heater Abnormality Determination Process According to Third Embodiment>

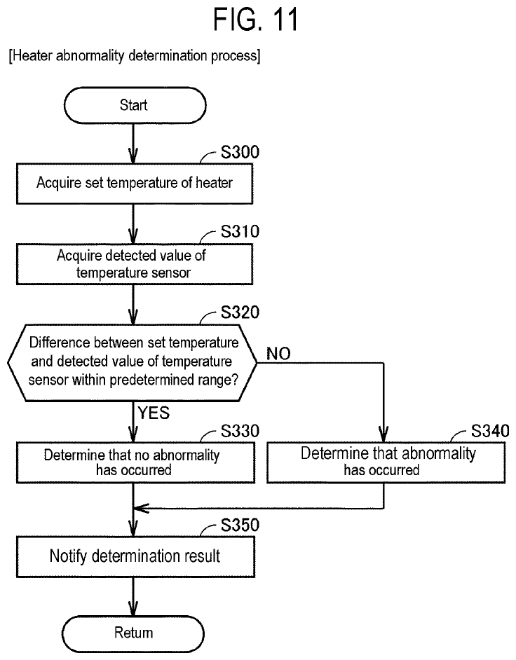

FIG. 11 is a flowchart of an abnormality determination process for the heater according to the third embodiment. In the third embodiment, a set temperature of the heater 110 is acquired (step S300). As described above, the CPU 210 supplies electric power so that the temperature of the heater 110 is set to be 200 degrees C. or lower.

At this time, a target temperature of the heater 110 is referred to as a set temperature. The CPU 210 determines a current value to be applied to the heater 110 according to the set temperature. The set temperature is determined by the CPU 210, for example, based on the detected value of the temperature sensor that detects the temperature around the liquid leakage sensor 100B (not shown). In addition, the CPU 210 adjusts the temperature of the heater 110 by a feedback control using the detected value of the temperature sensor 130. That is, the CPU 210 adjusts the set temperature of the heater 110 so that the detected value of the temperature sensor 130 falls within a predetermined range based on the environmental temperature around the liquid leakage sensor 100B. The set temperature may be determined as, for example, 150 degrees C. In this case, the CPU 210 acquires in step 300 that 150 degrees C. is set as the set temperature.

The CPU 210 acquires the detected value of the temperature sensor 130 (step S310). Subsequently, the CPU 210 determines whether or not a difference between the set temperature acquired in step S300 and the detected value acquired in step S310 is within a predetermined range (step S320). That is, in step S320 in the third embodiment, it is determined whether or not the temperature of the heater 110 is rising in accordance with the set temperature. The predetermined range is, for example, +10 degrees C. from the set temperature. When the set temperature is 150 degrees C., the CPU 210 determines whether or not the temperature of the heater 110 is within a range of 140 degrees C. or higher and 160 degrees C. or lower.

When the difference between the set temperature and the detected value of the temperature sensor 130 is within the predetermined range (“YES” in step S320), the CPU 210 determines that the temperature of the heater 110 is rising in accordance with the set temperature and no abnormality has occurred (step S330). When the difference between the set temperature and the detected value of the temperature sensor 130 is not within the predetermined range (“NO” in step S320), the CPU 210 determines that the temperature of the heater 110 is not rising in accordance with the set temperature and an abnormality has occurred in the liquid leakage sensor 100B (step S340).

The CPU 210 notifies the determination result of step S330 or step S340 (step S350). As a result, a user can be notified of an abnormality related to an excessive temperature rise of the heater 110 or an insufficient temperature rise of the heater 110.

### SUPPLEMENTARY NOTES

### (Supplementary Note 1, FIGS. 1 to 5)

According to an embodiment of the present disclosure, a liquid leakage detection system 10 that detects a liquid, includes: a liquid leakage sensor 100 including a first detector 120 that detects the adhesion of the liquid based on a change in impedance between a first electrode 120L and a second electrode 120R; and a control device 200 configured to acquire information including the impedance between the first electrode 120L and the second electrode120R. The liquid leakage sensor 100 includes a heater 110 that heats the first electrode 120L and the second electrode 120R. The control device 200 is further configured to determine whether or not liquid leakage or dew condensation has occurred based on the impedance between the first electrode 120L and the second electrode 120R that are in a state of being heated by the heater (step S180), and notify the determination result (step S190).

### (Supplementary Note 2, FIGS. 1, 4, and 5)

In the liquid leakage detection system 10 of Supplementary Note 1, the control device 200 is further configured to: acquire information including the impedance between the first electrode 120L and the second electrode 120R that are in a state of being not heated by the heater 110, as a first result (step S130); acquire information including the impedance between the first electrode 120L and the second electrode 120R that are in a state of being heated by the heater 110, as a second result (step S170); determine whether or not the liquid leakage or the dew condensation has occurred based on the first result and the second result (step S180); and notify the determination result (step S190).

### (Supplementary Note 3, FIGS. 7 and 8)

In the liquid leakage detection system 10A of Supplementary Note 1, the liquid leakage sensor 100A further includes a second detector 121 that detects the adhesion of the liquid based on a change in impedance between a third electrode 121L and a fourth electrode 121R. The control device 200 is further configured to: acquire information including the impedance between the third electrode 121L and the fourth electrode 121R that are in a state of being not heated by the heater 110, as a first result (step S220); acquire information including the impedance between the first electrode 120L and the second electrode 120R that are in a state of being heated by the heater 110, as a second result (step S210); determine whether or not the liquid leakage or the dew condensation has occurred based on the first result and the second result (step S230); and notify the determination result (step S240).

### (Supplementary Note 4, FIG. 5)

In the liquid leakage detection system 10 of Supplementary Note 2 or 3, the control device 200 is configured to: determine that the liquid leakage has occurred when the first result indicates the adhesion of the liquid and the second result indicates the adhesion of the liquid; determine that the dew condensation has occurred when the first result indicates the adhesion of the liquid and the second result does not indicate the adhesion of the liquid; and notify the determination result (step S190).

### (Supplementary Note 5, FIG. 5)

In the liquid leakage detection system 10 of any one of Supplementary Notes 2 to 4, the control device 200 is further configured to determine that an abnormality has occurred in the liquid leakage sensor when the first result does not indicate the adhesion of the liquid and the second result indicates the adhesion of the liquid, and notify the determination result (step S190).

### (Supplementary Note 6, FIGS. 9 to 11)

In the liquid leakage detection system 10B of any one of Supplementary Notes 1 to 5, the liquid leakage sensor 100B further includes a temperature sensor 130 that measures a temperature of the first detector 120. The control device 200 is further configured to: acquire a set temperature of the heater 110 (step S300); acquire a detected value of the temperature sensor 130 (step S310); when a difference between the set temperature and the detected value of the temperature sensor 130 is not within a predetermined range (“NO” in step S320), determine that an abnormality has occurred in the liquid leakage sensor 100 (step S340); and notify the determination result (step S350).

### (Supplementary Note 7, FIGS. 9 to 11)

In the liquid leakage detection system 10B of Supplementary Note 6, the control device 200 is further configured to adjust the set temperature of the heater 110 so that the detected value of the temperature sensor 130 is within the predetermined range, based on an environmental temperature around the liquid leakage sensor 100B.

### (Supplementary Note 8, FIGS. 1 to 3B)

According to another embodiment of the present disclosure, a liquid leakage sensor 100 that detects a liquid, includes: a first detector 120 that detects adhesion of the liquid based on a change in impedance between a first electrode 120L and a second electrode 120R; and a heater 110 that heats the first electrode and the second electrode.

### (Supplementary Note 9, FIGS. 2 to 3B)

In the liquid leakage sensor 100 of Supplementary Note 8, the heater 110 is a micro-heater.

### (Supplementary Note 10, FIGS. 2 to 3B)

The liquid leakage sensor of Supplementary Note 8 or 9 further includes: a substrate Sb1 having a main surface Sf1; and an insulator Ly including a first insulating layer L1, a second insulating layer L2, and a third insulating layer L4. The first insulating layer L1, the second insulating layer L2, and the third insulating layer L4 are stacked on the main surface Sf1 in an order of the third insulating layer L4, the second insulating layer L2, and the first insulating layer L1. The second insulating layer L2 includes the first electrode 120L and the second electrode120R. The third insulating layer L4 includes the heater110. The first insulating layer L1 is formed with an opening Op2 penetrating in a normal direction of the main surface Sf1. The first electrode 120L and the second electrode 120R are exposed in a region overlapping with the opening Op2 when the main surface Sf1 is viewed from above.

### (Supplementary Note 11, FIGS. 3A and 3B)

The liquid leakage sensor 100 of any one of Supplementary Notes 8 to 10 further includes: connectors Cn2 and Cn3 each connecting the heater 110 and a first external device; and connectors Cn1 and Cn4 each connecting the first detector 120 and a second external device. The connectors Cn1 to Cn4 are covered with a waterproof resin Rc1.

### (Supplementary Note 12, FIGS. 3A and 3B)

In the liquid leakage sensor 100 of any one of Supplementary Notes 8 to 11, the first electrode 120L and the second electrode 120R have a combteeth-like shape.

### (Supplementary Note 13, FIGS. 3A and 3B)

In the liquid leakage sensor 100 of any one of Supplementary Notes 8 to 12, a base material of the first electrode 120L and the second electrode 120R contains any one of aluminum, copper, and platinum.

### (Supplementary Note 14, FIG. 4)

In the liquid leakage sensor 100 of any one of Supplementary Notes 8 to 13, a temperature of the heater 110 is set to be equal to or higher than an environmental temperature around the liquid leakage sensor 100 and equal to or lower than 200 degrees C.

### (Supplementary Note 15, FIGS. 7 and 8)

The liquid leakage sensor 100A of any one of Supplementary Notes 8 to 14 further includes a second detector 121 that detects the adhesion of the liquid based on a change in impedance between a third electrode 121L and a fourth electrode 121R.

### (Supplementary Note 16, FIGS. 9 to 11)

The liquid leakage sensor 100B of any one of Supplementary Notes 8 to 15 further includes a temperature sensor 130 that measures a temperature of the first detector 120.

Although the embodiments of the present disclosure have been described as above, the above-described embodiments can be modified in various ways. In addition, the scope of the present disclosure is not limited to the above-described embodiments. The scope of the present disclosure is indicated by the claims and is intended to include all changes within the meaning and scope equivalent to the claims.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A liquid leakage detection system that detects a liquid, comprising:
a liquid leakage sensor including a first detector that detects adhesion of the liquid based on a change in impedance between a first electrode and a second electrode; and
a control device configured to acquire information including the impedance between the first electrode and the second electrode,
wherein the liquid leakage sensor includes a heater that heats the first electrode and the second electrode, and
wherein the control device is further configured to determine whether or not liquid leakage or dew condensation has occurred based on the impedance between the first electrode and the second electrode that are in a state of being heated by the heater, and notify the determination result.

2. The liquid leakage detection system of claim 1, wherein the control device is further configured to:
acquire information including the impedance between the first electrode and the second electrode that are in a state of being not heated by the heater, as a first result;
acquire information including the impedance between the first electrode and the second electrode that are in a state of being heated by the heater, as a second result;
determine whether or not the liquid leakage or the dew condensation has occurred based on the first result and the second result; and
notify the determination result.

3. The liquid leakage detection system of claim 1, wherein the liquid leakage sensor further includes a second detector that detects the adhesion of the liquid based on a change in impedance between a third electrode and a fourth electrode, and
wherein the control device is further configured to:
acquire information including the impedance between the third electrode and the fourth electrode that are in a state of being not heated by the heater, as a first result;
acquire information including the impedance between the first electrode and the second electrode that are in a state of being heated by the heater, as a second result;
determine whether or not the liquid leakage or the dew condensation has occurred based on the first result and the second result; and
notify the determination result.

4. The liquid leakage detection system of claim 2, wherein the control device is further configured to:
determine that the liquid leakage has occurred when the first result indicates the adhesion of the liquid and the second result indicates the adhesion of the liquid;
determine that the dew condensation has occurred when the first result indicates the adhesion of the liquid and the second result does not indicate the adhesion of the liquid; and
notify the determination result.

5. The liquid leakage detection system of claim 2, wherein the control device is further configured to determine that an abnormality has occurred in the liquid leakage sensor when the first result does not indicate the adhesion of the liquid and the second result indicates the adhesion of the liquid, and notify the determination result.

6. The liquid leakage detection system of claim 1, wherein the liquid leakage sensor further includes a temperature sensor that measures a temperature of the first detector, and
wherein the control device is further configured to:
acquire a set temperature of the heater;
acquire a detected value of the temperature sensor;
when a difference between the set temperature and the detected value of the temperature sensor is not within a predetermined range, determine that an abnormality has occurred in the liquid leakage sensor; and
notify the determination result.

7. The liquid leakage detection system of claim 6, wherein the control device is further configured to adjust the set temperature of the heater so that the detected value of the temperature sensor is within the predetermined range, based on an environmental temperature around the liquid leakage sensor.

8. A liquid leakage sensor that detects a liquid, comprising:
a first detector that detects adhesion of the liquid based on a change in impedance between a first electrode and a second electrode; and
a heater that heats the first electrode and the second electrode.

9. The liquid leakage sensor of claim 8, wherein the heater is a micro-heater.

10. The liquid leakage sensor of claim 8, further comprising:
a substrate having a main surface; and
an insulator including a first insulating layer, a second insulating layer, and a third insulating layer,
wherein the first insulating layer, the second insulating layer, and the third insulating layer are stacked on the main surface in an order of the third insulating layer, the second insulating layer, and the first insulating layer,
wherein the second insulating layer includes the first electrode and the second electrode,
wherein the third insulating layer includes the heater,
wherein the first insulating layer is formed with an opening penetrating in a normal direction of the main surface, and
wherein the first electrode and the second electrode are exposed in a region overlapping with the opening when the main surface is viewed from above.

11. The liquid leakage sensor of claim 8, further comprising:
a first connector that connects the heater and a first external device; and
a second connector that connects the first detector and a second external device,
wherein the first connector and the second connector are covered with a waterproof resin.

12. The liquid leakage sensor of claim 8, wherein the first electrode and the second electrode have a combteeth-like shape.

13. The liquid leakage sensor of claim 8, wherein a base material of the first electrode and the second electrode contains any one of aluminum, copper, and platinum.

14. The liquid leakage sensor of claim 8, wherein a temperature of the heater is set to be equal to or higher than an environmental temperature around the liquid leakage sensor and equal to or lower than 200 degrees C.

15. The liquid leakage sensor of claim 8, further comprising a second detector that detects the adhesion of the liquid based on a change in impedance between a third electrode and a fourth electrode.

16. The liquid leakage sensor of claim 8, further comprising a temperature sensor that measures a temperature of the first detector.
